(19) United States
(12) Patent Application Publication
(10) Pub. No.: US 2004/0033833 A1
(43) Pub. Date: Feb. 19, 2004

(54) Interactive redemption game

(76) Inventors: Rick A. Briggs, Springfield, IL (US); Denise Chapman Weston, Wakefield, RI (US)

Correspondence Address: LAW OFFICES OF JONATHAN A. BARNEY, ESQ., 312 SIGNAL ROAD, SUITE 200, NEWPORT BEACH, CA, 92663, US

(21) Appl. No.: 10/400,195

(22) Filed: Mar. 25, 2003

Related U.S. Application Data
(60) Provisional application No. 60/367,427, filed on Mar. 25, 2002.

(51) Int. Cl. G06F 17/00

(52) U.S. Cl. 463/42

(57) ABSTRACT

An interactive soft-play structure and redemption game is provided. The game utilizes electronically identifiable objects, cards, bands, tags and/or the like, to provide an interactive game play experience generally simulative of a computer adventure game experience. Play participants are challenged to work and cooperate with other play participants to find identified objects, clues or other information and to use the objects, clues or information to solve various puzzles or problems that present encumbrances inhibiting players' advancement in the game. Each play participant possesses a unique RFID band, card or the like, that electronically identifies the play participant and enables the play system to award and track points or other rewards to successful play participants individually or working with other play participants as a team. The game in accordance with the invention provides the intellectual challenge and excitement of a computer adventure game, but with tangible interactives, physical challenges, and social interaction.

### RELATED APPLICATIONS

This application claims priority under 35 U.S.C. § 119(e) to U.S. provisional application Ser. No. 60/367,427, filed Mar. 25, 2002, the entire disclosure of which is hereby incorporated by reference.

### BACKGROUND OF THE INVENTION

1. Field of the Invention

The present invention relates to redemption games and, in particuclar, to interactive redemption games utilizing electronically-identifiable objects or tags to provide a unique interactive play experience.

2. Description of the Related Art

Family entertainment centers, restaurant play structures and other similar facilities are well known for providing play and interaction among play participants playing in, or around an entertainment facility and/or play structure. A wide variety of commercially available soft-play structures are known for providing entertainment for children and profit opportunities for restaurant and entertainment centers that own and operate them. Redempton arcade games are also known that allow play particpatns to win and collect tickets and to redeem the tickets for prizes.

However, there is always a demand for more exciting and entertaining play attractions and games that increase the learning and entertainment opportunities for children and stimulate creativity and imagination.

### SUMMARY OF THE INVENTION

The invention provides a unique play attraction, redemption game system and method of game play wherein gaming is carried out within a themed physical soft-play attraction comprising an existing or specially configured entertainment facility or play structure. The game utilizes electronically identifiable objects, such as colored balls, shaped objects, cards, bands, RFID-tagged objects and/or the like, to provide an interactive game play experience generally simulative of a computer adventure game experience. Play participants are challenged to work and/or cooperate with other play participants to find identified objects, clues and/or other information and to use the objects, clues and/or information to solve various puzzles or problems that present encumbrances inhibiting a players advancement in the game. Preferably, each play participant also possesses a unique RFID band, card or the like, that electronically identifies the play participant and enables the play system to award and track points or other rewards to successful play participants individually or working with other play participants as a team. Thus, play participants participate in a computer-orchestrated adventure game, while using a physical play space and physical objects to overcome both physical and mental challenges presented by the game.

In accordance with one embodiment the present invention provides a method and system of interactive game play. The game includes a plurality of electronically distinguishable play objects and one or more consoles or stations adapted to distinguish the play objects electronically. The game challenges play participants to find and use identified objects in identified consoles.

In accordance with another embodiment the present invention provides a method game play wherein play participants participate in a computer driven adventure game, but using physical play space and physical objects capable of interacting electronically with the computer driven gaming system.

In accordance with another embodiment the present invention provides a modified computer game carried out by one or more play participants within a themed soft-play structure using a computer interface comprising wireless ID tags worn by play participants and electronically identifiable play objects. Optional redemption coupons, tickets, prize and/or the like may be awarded to play participants as they successfully compete each task.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and its essential features and advantages, certain preferred embodiments and modifications thereof will become apparent to those skilled in the art from the detailed description herein having reference to the figures that follow, of which:

FIG. 1 is an elevation view of one embodiment of an interactive soft-play structure incorporating features and advantage in accordance with the present invention;

FIG. 2 is a top plan view of the play structure of FIG. 1;

FIG. 3 is a perspective view of one embodiment of an interactive game console having features and advantages in accordance with the present invention;

FIG. 4A is a detail plan view of one embodiment of an RFID tag device for use in accordance with one preferred embodiment of an interactive soft-play structure and game having features and advantages in accordance with the present invention;

FIG. 4B is a schematic circuit diagram of one embodiment of an RFID tag device, illustrating the basic organization and function of the electronic circuitry comprising the RFID tag device of FIG. 4A for use in accordance with the present invention;

FIGS. 5A and 5B are schematic diagrams illustrating typical operation of the RFID tag device of FIG. 4; and

FIGS. 6A and 6B are a simplified schematic diagrams of an RFID read/write system for use with the RFID tag device of FIG. 4 and having features and advantages in accordance with the present invention.

### DETAILED DESCRIPTION OF THE PREFERRED EMBODIMENTS

Basic System and Framework

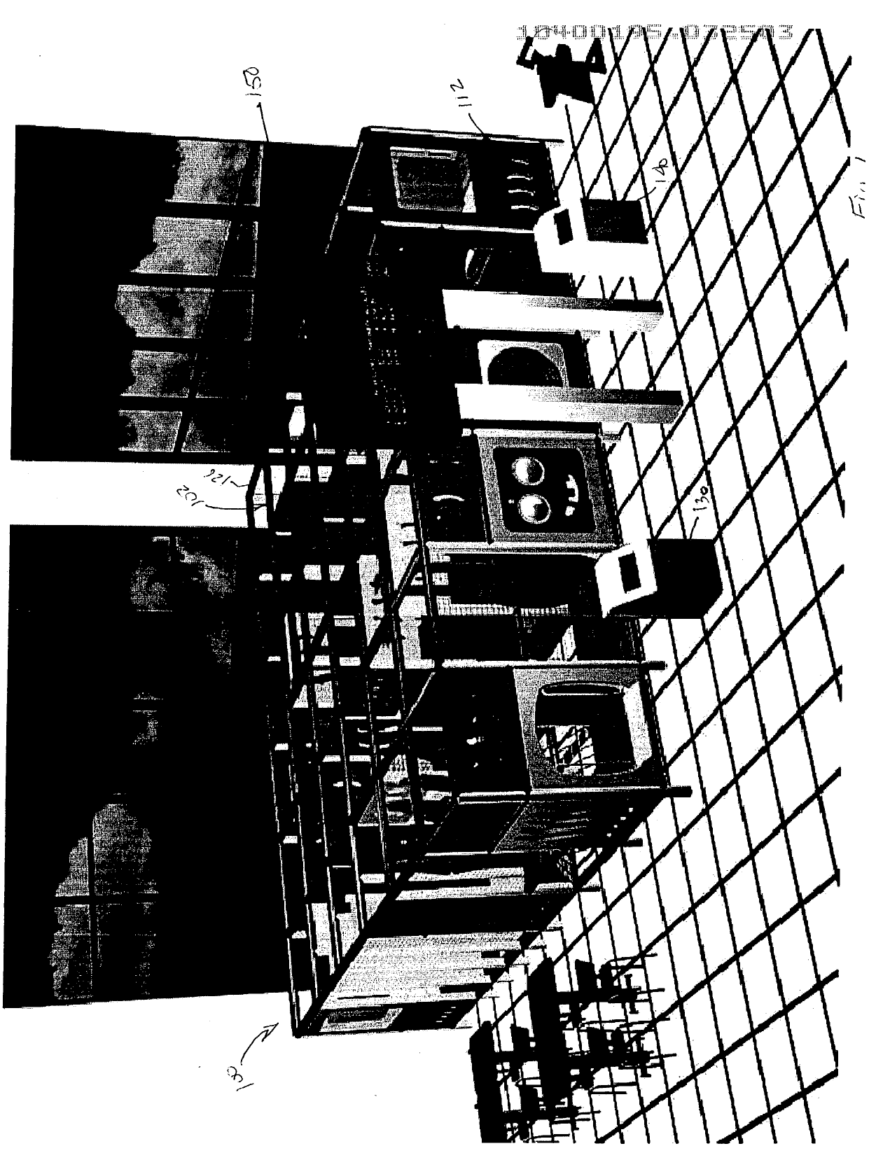

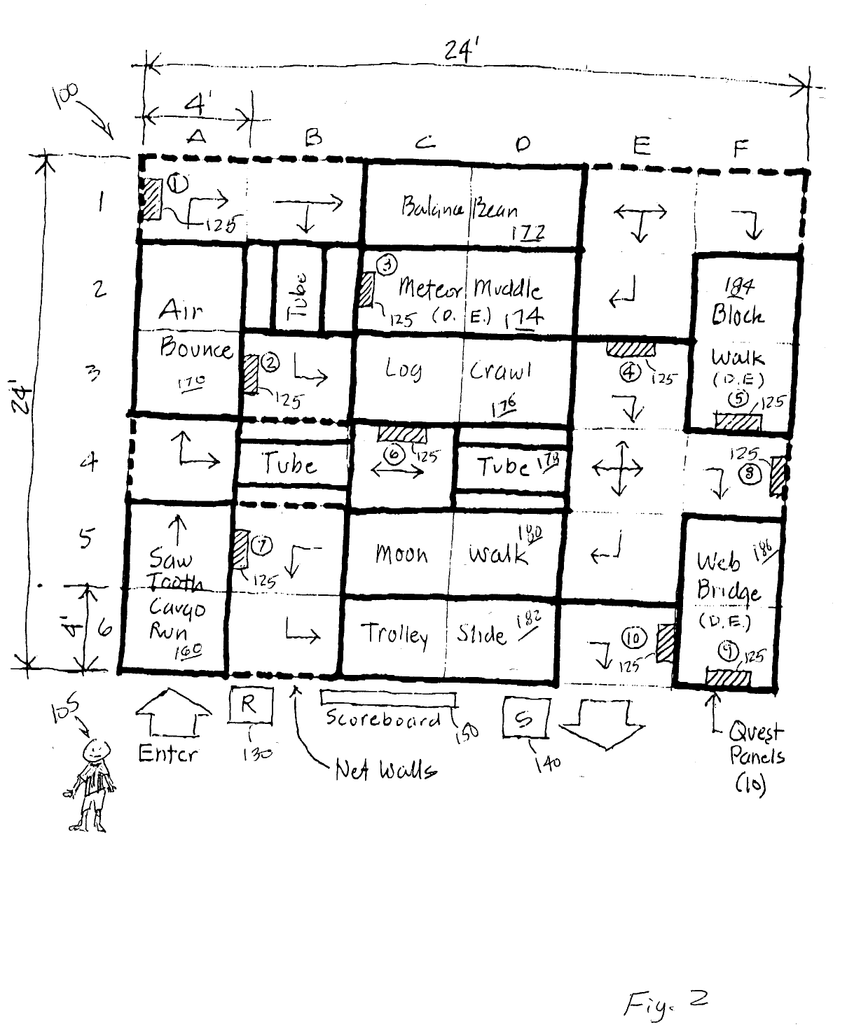

FIGS. 1-2 illustrate one preferred embodiment of an interactive soft-play structure 100 configured and adapted to facilitate an interactive redemption (or non-redemption) game having features and advantages in accordance with the present invention. For ease of description and understanding the particular soft-play structure illustrated is laid out in one level. However, those skilled in the art will readily appreciate that the play structure may also be constructed and laid out in multiple levels, as desired, including multiple play levels, rooms, and various themed slides, chutes, climbing nets, and other play devices or props to be enjoyed by multiple play participants. Within this play structure 100, play participants 105 embark on a quest to find and use various electronically-identifiable objects to solve problems, operate machinery, fix broken machinery and/or the like.

Preferably, each play participant 105 and/or group of participants is uniquely identified via an RFID tag, card, bracelet and/or the like. Identification information, such as play participant name, age, group affiliation, etc. are entered using a registration station 130 located adjacent the play structure 100. As each play participant moves throughout the play structure and interacts with various interactive devices comprising the game and distributed throughout the play structure 100, the play system is able to track and identify relevant attributes of play participant, such as points accumulated, levels achieved, special skills acquired, etc. Play participants advance in the game by successfully completing various challenges presented throughout the play structure and/or throughout the course of game play.

Points are tracked and displayed on a score board 150. Scores may be reported directly to the score board by each console 125, such as via Ethernet or wireless communication. Alternatively, an intermediate point station 140 may be used to periodically collect and report points for each play participant 105 or group of play participants. In that case, play participants would present their band or RFID tags to the point station 140 to determine their points. The point station incorporates a RFID reader, which reads the RFID tag and obtains and displays the points for each participant. This information is then provided to the score board 150 for display. Optionally, point information and other information may be communicated via internet to a central host and/or one or more other interactive soft-play game centers.

Earned points may be used to receive redemption tickets, prizes and/or other incentives. For example, the point station 140 could be configured to issue redemption tickets according to total points accumulated by each play participant. Play participants can then redeem the tickets for prizes, freebies, discounts or the like. Alternatively, the points stored on each RFID tag may be used to access and play associated games, such as video games and the like.

The play structure 100 itself preferably comprises a multi-level structure constructed using any one of an number of materials and construction techniques well known to those skilled in the art. The structure 100 may be suitable for either outdoor or indoor use, as desired. Preferably, the structure 100 comprises a supporting framework 102 formed from a plurality of interconnected support members 126, comprising columns, pylons, beams, connectors and the like. The support members 126 may be formed from any combination of convenient materials having sufficient strength and durability for safely supporting multiple play participants 105. For example, plastic or PVC pipes, steel pipes, I-beams or channel beams, reinforced concrete beams/columns, and the like may all be used to form the supporting framework 102.

For visual appeal and added safety, optional decorative panels 112, railings and/or roofing elements may be provided, as desired, to shade play participants 105 from the sun (for outdoor play structures), to prevent play participants from falling off the structure 100, or to complement a particular desired theme of the play structure 100. Decorative panels may be formed of wood, fiberglass or other reinforced fiber, PVC, aluminum, steel or a variety of other suitable materials, as desired. Corrosion-resistant materials are preferred, particularly if the play structure 100 is to be used outdoors. Of course, those skilled in the art will readily appreciate that a wide variety of other decorative or thematic elements may be incorporated into the overall design of the play structure 100 in order to provide added safety and/or to help convey a particular desired play theme.

Optionally, a suitable play media, such as foam or rubber balls or similar objects, may be provided for use throughout the structure to provide a tactile interactive play experience. A number of conduits or other transport means are preferably provided throughout the framework 102 for transporting play media to and from the various play areas in the play structure 100. The conduits may be formed from plastic hosing or PVC pipes joined together using commercially available fittings, as is well known in the art. Conduits may also be formed from a wide variety of other suitable materials such as steel pipe, ceramic/clay pipe, or they may be formed as open channels and/or runners, as desired. Clear or colored/transparent plastic pipes having an inner diameter of about 2⅛″-6½″, and more preferably about 3-4″, are particularly preferred for aesthetic appeal and added excitement. Alternatively, larger or smaller diameter conduits or conduits having different colors or shapes may be used, as desired, to accommodate various sizes and shapes of balls or other play media. Play media may be conveniently transported by use of pressurized air or other suitable means, as desired. Various participant-operated or “magically” actuated conveyors may also be employed to circulate balls or other play media from one area of the structure 100 to another, as desired.

The play structure 100 also preferably incorporates a number of other conventional (passive) play elements, such as climbing nets (“saw tooth cargo run”) 160, air bounce/trampolines 170, balance beams 172, hanging bumper-bags (“meteor muddle”) 174, log crawl 176, tunnels 178, moon jumps 180, trolley slides 182, block walks 184 swinging/web bridgesl86, slides and the like. These provide entertaining physical challenges and allow play participants to safely negotiate their way through the various areas of the play structure 100. Slides may be provided at the front, rear, and/or sides of the play structure 100 and may be straight, curved, or spiral-shaped, as desired. They may also be enclosed and tube-like or open and exposed to flying play media, as desired. Alternatively, those skilled in the art will readily appreciate that the size, number, and location of the various slides 110 can be varied, as desired, while still enjoying the benefits and advantages of the present invention.

Multiple ball pits and the like may also be provided at various locations throughout the play structure. Those skilled in the art will readily appreciate that a wide variety of other passive play elements, such as funny mirrors, rotating tunnels, trampolines, climbing bars, swings, etc. may all be used to create a desired play environment for carrying out the features and advantages as of the present invention as taught herein.

While a particular preferred play environment and play structure 100 has been described, it will be readily apparent to those skilled in the art that a wide variety of other possible play environments, play structures, entertainment centers and the like may be used to create an interactive play environment within which the invention may be carried out. For instance, a suitable play structure may be constructed substantially entirely of molded or contoured concrete, fiberglass or plastic, as desired. Alternatively, a suitable play structure may be constructed entirely or partially from conduits or pipes which also transport play media to and from various locations throughout the play structure. Alternatively, the play environment need not comprise a play structure at all, but may be simply a themed play area, or even a multipurpose area such as a restaurant dining facility, family room, bedroom or the like.

FIG. 2 is a top plan view of one embodiment of an interactive soft-play structure having features and advantages of the present invention. A plurality of interactive consoles 125 are distributed throughout the structure 100. Each console is preferably equipped with an RFID reader adapted to electronically identify play participants via one or more wireless RFID tags or bands worn or possessed by play participants. Optional points, redemption coupons, tickets, prize and/or the like may be awarded to play participants as they successfully complete each task. These may be printed using a dispenser or the like and/or the may be recorded electronically via the RFID tag.

Game Play

Game play begins at the introductory registration station 130. Here play participants 105 register to play the game, input relevant information about themselves, such as name, age, group affiliation. Play participants then proceed into the play structure 100 and to the various game consoles 125. The game consoles 125 preferably challenge play participants to complete a specified task (e.g., find a hidden object or clue, answer a multiple-choice question, push a button(s), jump over light beam sensor, or the like).

Before play participants can begin the game, the RF Tag Reader/Writer first reads the play participant's UPIN and/or UGIN and confirms the player's status. The console then prompts the play participant to complete a specified task. Once the interface senses that the requested task has been completed, the RF Tag Reader/Writer writes updated information to the play participant's RFID tag. This information may include, station number visited, updated number of points accumulated, error check bits/flags and/or various other information.

At any time during game play a play participant can visit one or more point stations 140 to determine his or her status in the game and the total points accumulated. The point station may comprise a simple RF Tag Reader and associated display and/or it may include a guest interface or other input device for more sophisticated functionality. Preferably, at least one point station 140 is disposed near the exit of the soft-play structure. Here players can verify and log their final point tally. The final point station preferably includes a RF Tag Reader/Writer. Various software in the final point station may be used to log and verify the final recorded score and communicate such information to the main score board 150. Optionally, once the score has been logged and verified the final point station may “reset” the play participant's RFID tag so that the play participant can turn in the RFID tag at the exit gate to be used by another play participant.

Game Consoles

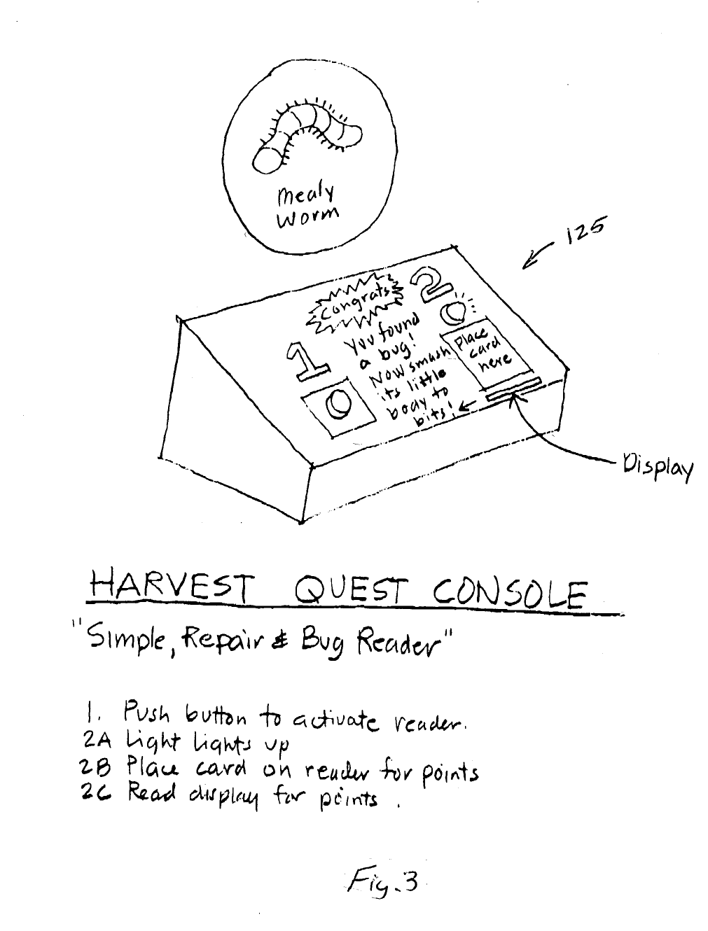

In the preferred embodiment illustrated and described above, multiple interactive quest consoles 125 are arranged throughout the structure 100. One preferred embodiment of a game console 125 is illustrated in FIG. 3. Each game console 125 preferably contains RFID readers/writers adapted to read and/or write to the RFID tags or bracelets worn by play participants 105. Game consoles-may be out in the open or hidden, as desired. Play participants 105 find each console and use the RFID tags/bands to receive points and/or complete a game. Preferably, game play follows a story line that play partipants learn as they play. Play participants may learn clues and gather objects or tools (real or imaginary/electronic) that enable them to progress through the game, solve a mystery, or complete a quest or treasure hunt. Preferably, the various consoles 125 are arranged and programmed such that they must be visited and operated in a particular order to complete the game and earn the maximum number of points. For example, certain consoles may only be activated if the play participant has already visited and received points or information from other consoles 105 within (or outside) the play structure 100. The game play may be similar to a typical interactive computer adventure game.

RFID Tags and Readers

As indicated above, each play participant 105 within the play structure 100 preferably receives an electronic identification device such as an RFID tag or transponder (“tag”). The tag allows play participants to electronically interact with the various quest consoles to achieve desired goals or produce desired effects within the play environment. Play participants preferably collect points or earn additional levels or ranks for each interactive console they successfully complete. In this manner, play participants 105 may compete with one another to see who can score more points and/or achieve the highest levels in the quest game.

RFID technology provides a universal and wireless medium for uniquely identifying objects and/or people and for wirelessly exchanging information over short and medium range distances (10 cm to 10 meters). Commercially available RFID technologies include electronic devices called transponders or tags, and reader/writer electronics that provide an interface for communicating with the tags. Most RFID systems communicate via radio signals that carry data either uni-directionally (read only) or, more preferably, bi-directionally (read/write).

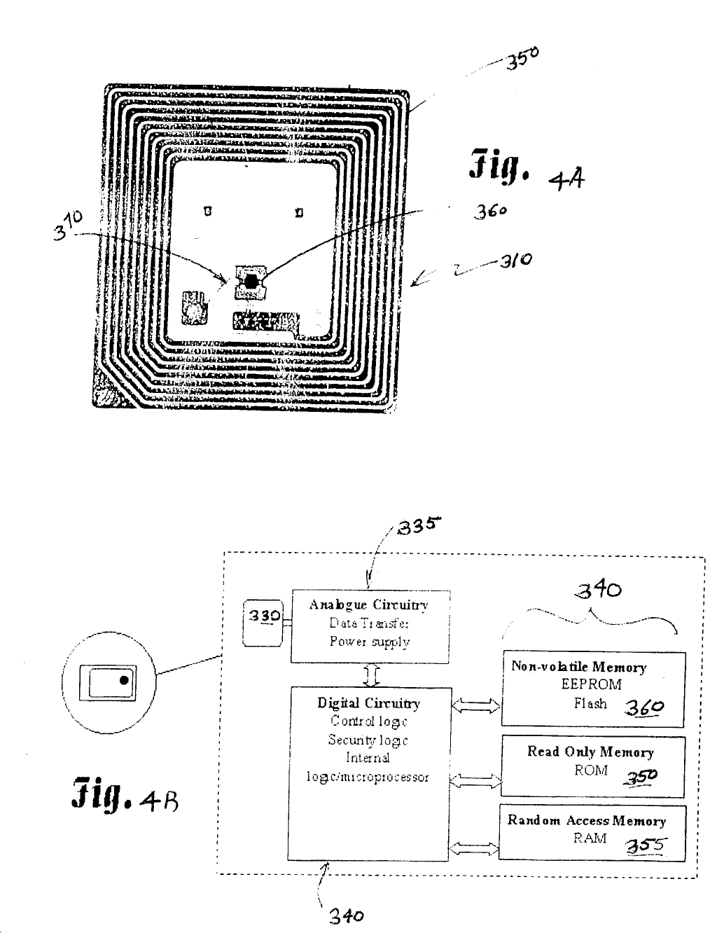

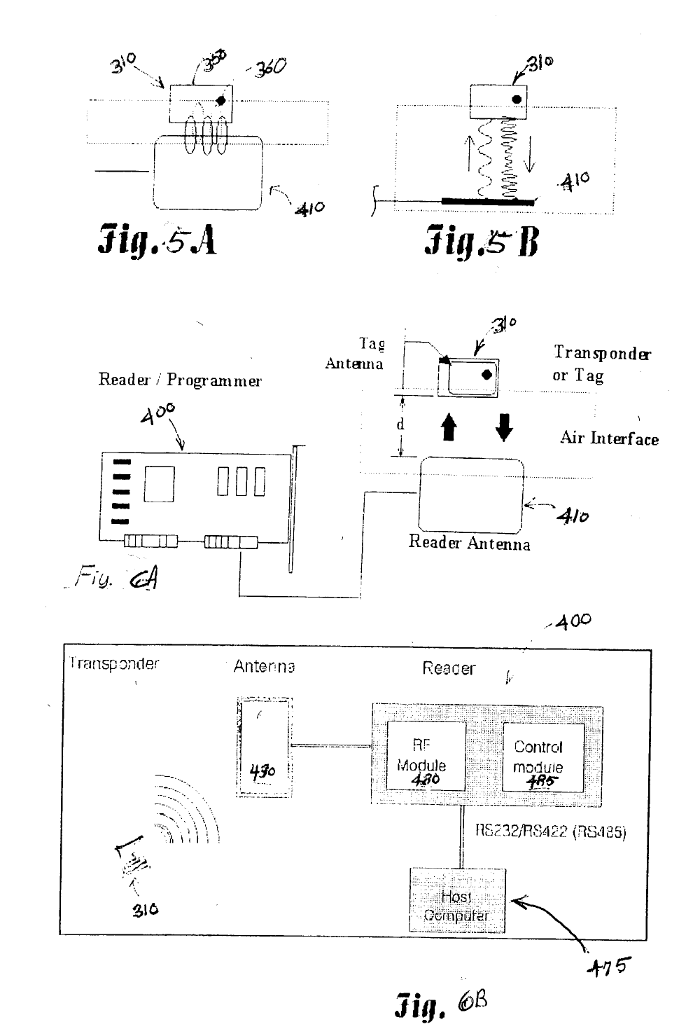

Several examples of RFID tags or transponders particularly suitable for use with the present invention have been illustrated and described herein. For example, in the particular preferred embodiments illustrated and described above, a 134.2 kHz/123.2 kHz, 23 mm glass transponder is preferably selected, such as available from Texas Instruments, Inc. (http://www.tiris.com, e.g., Product No. RI-TRP-WRHP). As illustrated in FIG. 21A, this transponder basically comprises a passive (batteryless) RF transmitter/receiver chip 240 and an antenna 245 provided within an hermetically sealed vial 250. A protective silicon sheathing 255 is preferably inserted around the sealed vial 250 between the vial and the inner wall of the tube 110 to insulate the transponder from shock and vibration. If desired, the RFID transponder 118 may be modified to provide an optional external interrupt/disable line 260, such as illustrated in FIG. 21A and as described in more detail above in connection with FIGS. 1 and 5.

However, those skilled in the art will readily appreciate that the invention is not limited to the specific RFID transponder devices disclosed herein, but may be implemented using any one or more of a wide variety of commercially available wireless communication devices such as are known or will be obvious to those skilled in the art. These include, without limitation, RFID tags, EAS tags, electronic surveillance transmitters, electronic tracking beacons, Wi-Fi, GPS, bar coding, and the like.

Of particular interest for purposes of practicing the present invention is the wide variety of low-cost RFID tags that are available in the form of a printed circuit on a thin, flat adhesive-backed substrate or foil. For example, the 13.56 mHz RFID tag sold under the brand name Tag-it™ and available from Texas Instruments, Inc. (http://www.tiris.com, Product No. RI-103-110A) has particular advantages in the context of the present invention. Paper thin and batteryless, this general purpose read/write transponder is placed on a polymer tape substrate and delivered in reels. It fits between layers of laminated paper or plastic to create inexpensive stickers, labels, tickets and badges. Tag-it™ inlays have a useful read/write range of about 25 cm and contain 256-bits of on-board memory arranged in 8×32-bit blocks which may be programmed (written) and read by a suitably configured read/write device.

Another RFID tagging technology of particular interest for purposes of practicing the present invention are the so-called “chipless” RFID tags. These are extremely low-cost RFID tags that are available in the form of a printed circuit on a thin, flat adhesive. These tags are similar in size, shape and performance to the Tag-it™ inlays described above, except that these tags require no on-board integrated circuit chip. Chipless RFID tags can be electronically interrogated to reveal a pre-encoded unique ID and/or other data stored on the tag. Because the tags do not contain a microchip, they cost much less than conventional RFID tags. An adhesive-backed chipless RFID tag with up to 10 meters range and 256 bits of data, can cost one tenth of their silicon chip equivalents and typically have a greater physical performance and durability. For example, a suitable chipless RFID tag is being made available from Checkpoint Systems under its ExpressTrak™ brand. Very inexpensive chipless RFID tags (and/or other types of RFID tags) may also be directly printed on paper or foil substrates using various conductive inks and the like, such as are available from Parelec Inc under its Parmod VLT™ brand.

FIG. 4A is a detailed schematic view of one embodiment of an RFID tag device 310 for use with one preferred embodiment of a quest game having features and advantages of the present invention. The tag 310 in the preferred embodiment illustrated preferably comprises a radio frequency tag pre-programmed with a unique person identifier number (“UPIN”) or quest object identification number (UOIN). Other stored information (either pre-programmed or programmed later) may include, for example, the play participant's name, age, rank or level achieved, total points accumulated, tasks completed, facilities visited, etc. The tag 310 generally comprises a spiral wound antenna 350, a radio frequency transmitter chip 360 and various electrical leads and terminals 370 connecting the chip 360 to the antenna 350.

The tag may be a passive tag 310 or battery-powered, as expedience and costs dictate. Preferably, the tag 310 is passive (requires no batteries) so that it is inexpensive to purchase and maintain. Such tags and various associated readers and other accessories are commercially available in a wide variety of configurations, sizes and read ranges. RFID tags having a read range of between about 10 cm to about 100 cm are particularly preferred, although shorter or longer read ranges may also be acceptable. The particular tag 310 illustrated is the 13.56 mHz tag sold under the brand name Taggit™ available from Texas Instruments, Inc. (http://www.tiris.com, Product No. RI-103-110A). The tag 310 has a useful read/write range of about 25 cm and contains 256-bits of on-board memory arranged in 8×32-bit blocks which may be programmed (written) and read by a suitably configured read/write device. If a longer read/write range (e.g., 1-100 meters) and/or more memory (e.g., 1-100 Mb) is desired, optional battery-powered tags may be used instead, such as the AXCESS active RFID network system available from AXCESS, Inc. and/or various other RF-based asset and people tracking applications known to those skilled in the art.

FIG. 4B is a simplified block diagram illustrating the basic organization and function of the electronic circuitry comprising the radio frequency transmitter chip 360 of the RFID tag device 310 of FIG. 4A. The chip 360 basically comprises a central processor 430, Analogue Circuitry 435, Digital Circuitry 440 and on-board memory 445. On-board memory 445 is divided into read-only memory (ROM) 450, random access memory (RAM) 455 and non-volatile programmable memory 460, which is available for data storage. The ROM-based memory 450 is used to accommodate security data and the tag operating system instructions which, in conjunction with the processor 430 and processing logic deals with the internal “house-keeping” functions such as response delay timing, data flow control and power supply switching. The RAM-based memory 455 facilitates temporary data storage during transponder interrogation and response. The non-volatile programmable memory 460 may take various forms, electrically erasable programmable read only memory (EEPROM) being typical. It is used to store the transponder data and is preferably non-volatile to ensure that the data is retained when the device is in its quiescent or power-saving “sleep” state. Various data buffers or further memory components (not shown), may be provided to temporarily hold incoming data following demodulation and outgoing data for modulation and interface with the transponder antenna 350. Analog Circuitry 335 provides the facility to direct and accommodate the interrogation field energy for powering purposes in passive transponders and triggering of the transponder response. Analog Circuitry also provides the facility to accept the programming or “write” data modulated signal and to perform the necessary demodulation and data transfer processes. Digital Circuitry 440 provides certain control logic, security logic and internal microprocessor logic required to operate central processor 430.

Advantageously, the UPIN stored on each tag 310 may be used to wirelessly identify and track individual play participants 105 within a play facility or park. Optionally, each tag 310 may also include a unique group identifier number or “UGIN” which may be used to match one or more play participants to a defined group or team. If desired, the tag 310 may be covered with an adhesive paper label (not shown) for surface adhesion to a quest object, clothes, or any other tag bearing surface. More preferably, the tag 310 may be molded and/or embedded into a relatively stiff plastic sheet substrate and/or transponder cylinder which holds and supports the tag 310. Optionally, the sheet substrate, transponder or other support structure may take on any other fanciful shape, as desired. The resulting structures may be inserted into and/or affixed to the various quest objects, and/or they may be worn externally by play participants (e.g., as a bracelet, necklace, key chain trinket, sticker, name badge, etc.).

In operation, various RFID reader (and/or reader/writer) devices are provided and may be distributed throughout the play structure 100. These readers are able to read the information stored on each tag 310 when the associated person or object is brought into suitable proximity of the reader (1-100 cm). Advantageously, because radio waves can easily penetrate solid objects, such as plastic and the like, the tag 310 can be mounted internally within a cavity of the quest object, thereby providing an internal communication and information storage means for each quest object. Tags can also be worn close to the body, such as around a person's wrist. Thus, the UPIN, UOIN and UGIN information can be conveniently read and easily communicated to a quest console, computer monitor, interactive game control system, display system or other tracking, recording or displaying device for purposes of identifying, logging and creating a record of each play participant's experience. Additional information (e.g., unique personality traits, special powers, skill levels, etc.) can also be easily stored on each tag, thus providing further character development and interactive gaming possibilities.

FIGS. 5 and 6 are simplified schematic illustrations of tag and reader operation. The tag 310 is initially activated by a radio frequency signal broadcast by an antenna 410 of an adjacent reader or activation device 400. The signal impresses a voltage upon the antenna 350 by inductive coupling which is then used to power the chip 360 (see, e.g., FIG. 4A). When activated, the chip 360 transmits via radio frequency a unique identification number preferably corresponding to the UPIN, UOIN and/or UGIN described above (see, e.g., FIG. 4A and associated discussion). The signal may be transmitted either by inductive coupling or, more preferably, by propagation coupling over a distance “d” determined by the range of the tag/reader combination. This signal is then received and processed by the associated reader 400, as described above, and then communicated to a host computer 475. If desired, the RFID tag or transponder 310 may also be configured for read/write communications with an associated reader/writer. Thus, the unique tag identifier number (UPIN, UGIN or UOIN) and any other stored information can be read, changed or other information may be added.

As indicated above, communication of data between a tag and a reader is by wireless communication. As a result, transmitting such data is possibly subject to the vagaries and influences of the media or channels through which the data has to pass, including the air interface. Noise, interference and distortion are potential sources of data corruption that may arise. Thus, those skilled in the art will appreciate that a certain degree of care should be taken in the placement and orientation of the various readers 400 so as to minimize the probability of such data transmission errors. Preferably, the readers are placed at least 30-60 cm away from any metal objects, power lines or other potential interference sources. Those skilled in the art will also recognize that the write range of the tag/reader combination is typically somewhat less (˜10-15% less) than the read range “d” and, thus, this should also be taken into account in determining optimal placement and positioning of each reader device 400.

Typical RFID data communication is asynchronous or unsynchronized in nature and, thus, particular attention should be given in considering the form in which the data is to be communicated. Structuring the bit stream to accommodate these needs, such as via a channel encoding scheme, is preferred in order to provide reliable system performance. Various suitable channel encoding schemes, such as amplitude shift keying (ASK), frequency shift keying (FSK), phase shift keying (PSK) and spread spectrum modulation (SSM), are well know to those skilled in the art and will not be further discussed herein. The choice of carrier wave frequency is also important in determining data transfer rates. Generally speaking the higher the frequency the higher the data transfer or throughput rates that can be achieved. This is intimately linked to bandwidth or range available within the frequency spectrum for the communication process. Preferably, the channel bandwidth is selected to be at least twice the bit rate required for the particular application.

The quest game in accordance with the above-described example provides a challenging, computer-orchestrated interactive gaming experience within a physical play space using electronically-identifiable physical objects as an interactive play medium. The game provides kids with the intellectual challenge and excitement of a computer adventure game, but with tangible interactives, physical challenges, and social interaction.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. A method and system of interactive game play, including a plurality of RFID game consoles and RFID tags, whereby play participants are challenged to find and interact with the game consoles to win points and redemption prizes.
